(19) United States
(12) Patent Application Publication
(10) Pub. No.: US 2012/0124008 A1
(43) Pub. Date: May 17, 2012

(54) SYSTEM AND METHOD FOR GENERATING COLLECTION OF MEDIA FILES

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/186,731

(22) Filed: Jul. 20, 2011

(30) Foreign Application Priority Data
Nov. 16, 2010 (TW) 99139289

(51) Int. Cl. G06F 17/30

(52) U.S. Cl. 707/687; 707/E17.005

(57) ABSTRACT

A media collection generating system includes a location module, a scanning module, and a verifying module. The location module specifies one or more locations where media files are stored. The scanning module scans the media files in the one or more locations. The collection generator generates a collection of the scanned media files. The verifying module verifies the media files in the collection and if a media file is invalid, deletes the media file from the collection.

### BACKGROUND

1. Technical Field

The disclosure generally relates to a system and method for generating a collection of media files in an electronic device.

2. Description of Related Art

Computer users often store music, movies, and other media files on their computers. By so doing, users can later play and record their music without having to get another copy. But filing systems in many computers are not geared to allow users to easily view and use their media files. Often users have to manually add or delete links to media files in a play list or a media library when the users add or delete media files stored in their computers. Therefore there is room for improvement in media management.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of an electronic device including a media collection generating system.

FIG. 2 is a schematic diagram of one embodiment of the function modules of the media collection generating system of FIG. 1.

FIG. 3 is a table representing some criteria of media files of various types.

FIG. 4 is an operational flow diagram representing an exemplary embodiment of a method for generating a collection of media files.

FIG. 5 is an operational flow diagram representing an exemplary embodiment of a method for managing the collection of media files when an external storage device is installed.

FIG. 6 is an operational flow diagram representing an exemplary embodiment of a method for managing the collection of media files when an external storage device is uninstalled.

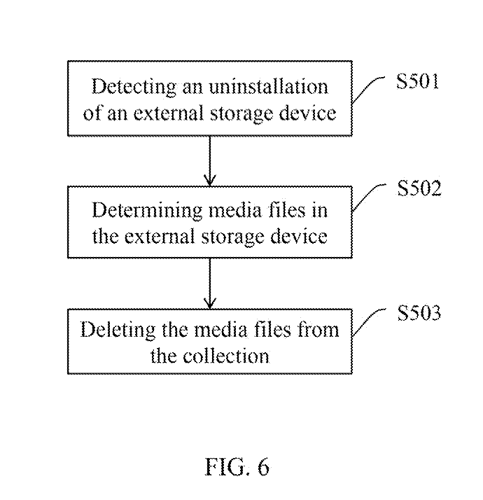

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

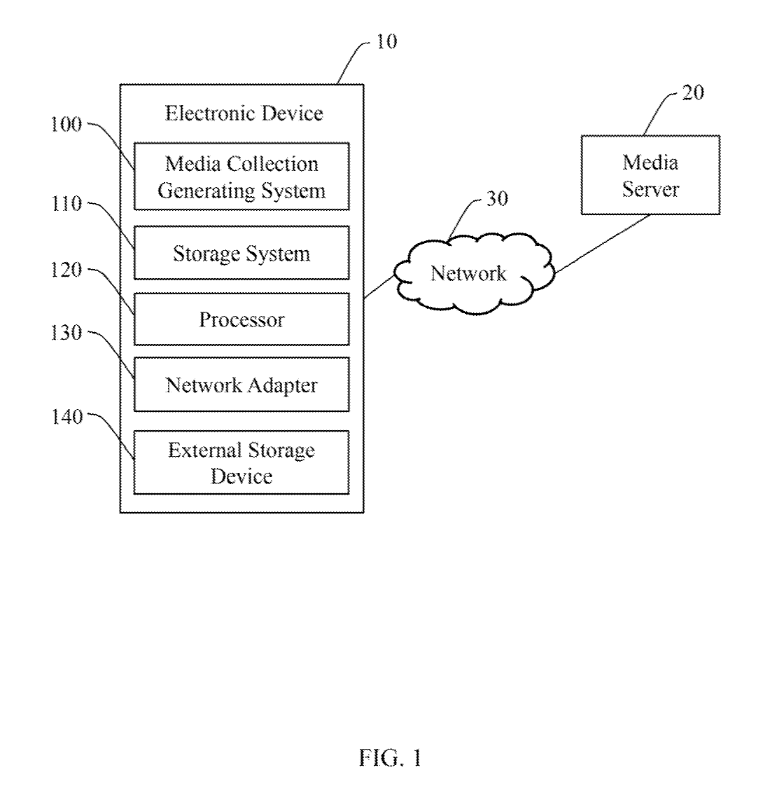

FIG. 1 is a schematic diagram of one embodiment of an electronic device 10. In the embodiment, the electronic device 10 may include a media collection generating system 100, a storage system 110, at least one processor 120, and a network adapter 130. The electronic device 10 implements the functions of the media collection generating system 100. The media collection generating system 100 may communicate with a media server 20 via a network 30 and receive media data from the media server 20. The electronic device 10 may be a desktop computer, a flat panel computer, a PDA or a smart phone. The media server 20 may provide media data in a file format or in a stream, in a variety of protocols.

In one embodiment, the storage system 110 may be a magnetic or an optical storage system, such as a hard disk drive, an optical drive, or a tape drive. The storage system 110 may store media files. The network adapter 130 may be a network interface card using a specific physical layer and data link layer standard such Ethernet or Wi-Fi. The network 30 may be a local area network (LAN) or a wide area network (WAN), such as the Internet.

An external storage device 140 may be connected to the electronic device 10. The external storage device 140 may store media files. The external storage device 140 may be an external hard disk drive, a compact flash card, or a floppy disk drive.

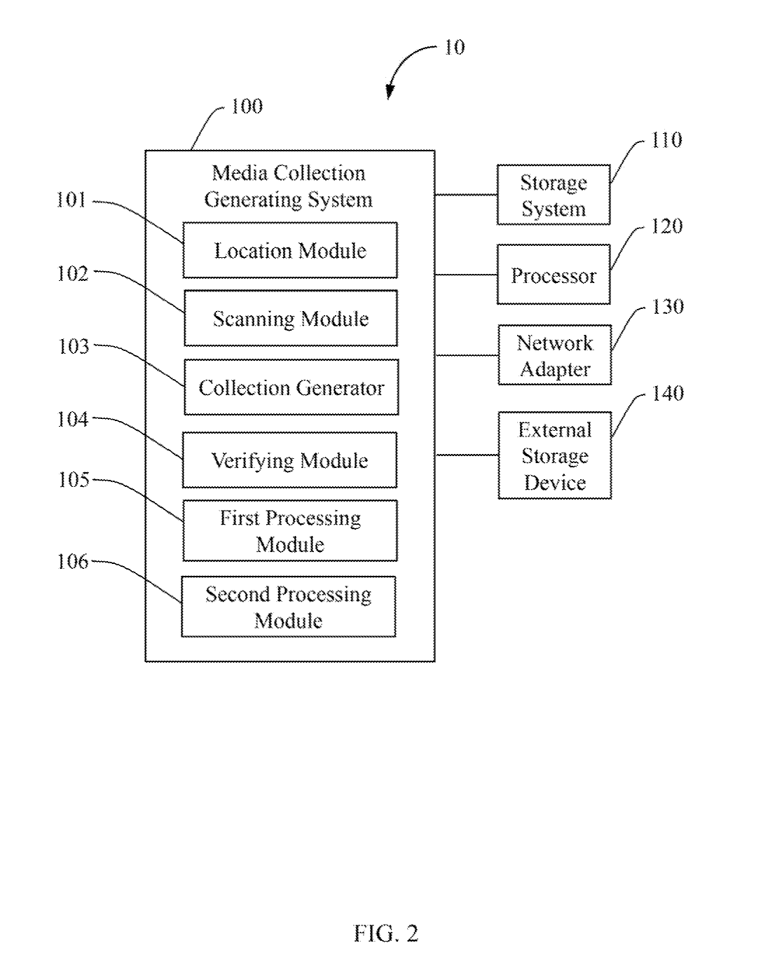

FIG. 2 is a schematic diagram of one embodiment of the function modules of the media collection generating system 100. In the embodiment, the media collection generating system 100 includes a location module 101, a scanning module 102, a collection generator 103, a verifying module 104, a first processing module 105, and a second processing module 106.

The location module 101 may record and specify one or more locations where media files are stored. The location module 101 may point to a local folder of the storage system 110, for example, “D:\music\”. The location may also point to a remote location in the media server 20 and refer to a specific protocol. For example, the location may point to a location of the media server 20 “ftp://10.0.0.20/music/”. The media files may include audio files, video files, and image files.

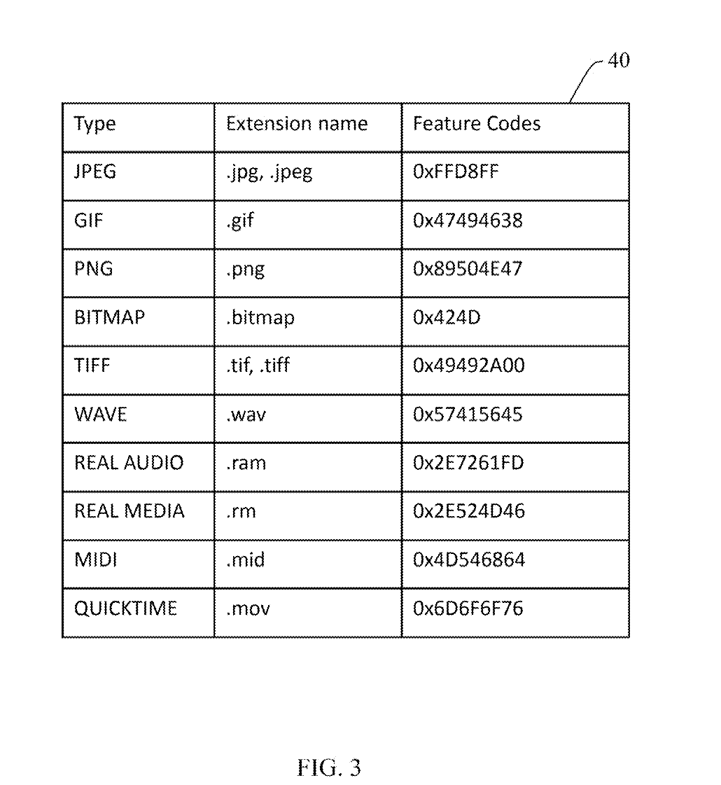

The scanning module 102 may scan the media files in the one or more locations. The scanning module 102 may scan the extension names of all files in the one or more locations. When the extension name of a file meets the extension name criteria of media files generally, the scanning module 102 will determine that that file is a media file. Media files of a media type always have one or more specific extension names. For example, in general the extension name of a JPEG file is “.jpg” or “.jpeg”. In FIG. 3, a table 40 presents exemplary extension name criteria of some media types. Every media type is correlated with at least one extension name. In one embodiment, the extension name criteria of media files can be stored in a file in an XML format.

The collection generator 103 may generate a collection of the media files. The collection generator 103 may organize the media files by their title, by artist, by album name, by genre, or by rating in the collection.

The verifying module 104 may verify whether the media files in the collection are valid or not. A media file of a media type has a specific series of bytes called feature codes in its data. In FIG. 3, the table 40 presents some exemplary feature codes criteria of some media types. For example, a valid JPEG file contains 3 bytes of “0xFFD8FF” in its header data. If a media file does not contain the 3 bytes of “0xFFD8FF” in its header data”, the media file may be determined to be an invalid JPEG file. In one embodiment, the feature codes criteria of some or all media files are stored in a file in an XML format.

In order to verify the media files in the collection, the verifying module 104 may read a plurality of bytes from data of a media file in the collection and check whether the plurality of bytes meets the feature codes criteria of media files. When the plurality of bytes does meet the feature codes criteria, the verifying module 104 may determine the media file as a valid media file. When the plurality of bytes does not meet any one of the feature codes criteria of media files, the verifying module 104 may determine the media file to be an invalid media file and delete the media file from the collection created by the generator 103 of this embodiment.

The first processing module 105 may monitor a hardware installation event. When the first processing module 105 detects an installation of the external storage device 140, the processing module 105 may scan media files in the external storage device 140 and add the media files, scanned in the external storage device 140, to the collection.

The second processing module 106 may monitor a hardware uninstallation event. When the second processing module 106 detects an uninstallation of the external storage device 140, the second processing module 106 may determine all media files out of all the files in the external storage device 140 and delete the particular media files located in the external storage device 140 from the collection.

FIG. 3 is a flowchart illustrating one embodiment of a method of generating a collection of media files. The method may include the following steps.

In step S301, the location module 101 records and specifies one or more locations where media files are stored.

In step S302, the scanning module 102 scans the media files in the one or more locations.

In step S303, the collection generator 103 generates a collection of the media files.

In step S304, the verifying module 104 verifies whether all or any of the media files in the collection are valid or not. When a media file is determined to be invalid, the verifying module 104 deletes the media file from the collection.

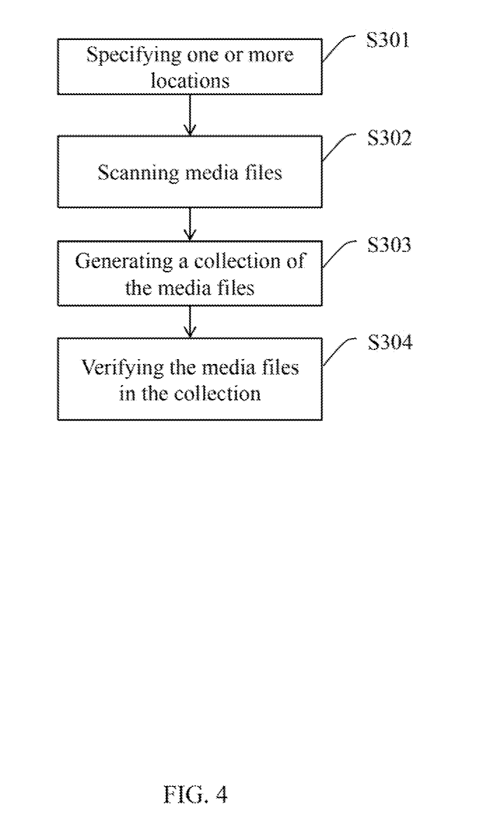

FIG. 4 is a flowchart illustrating one embodiment of a method of managing the collection of media files when an external storage device is installed. The method may include the following steps.

In step S401, the first processing module 105 detects an installation of the external storage device 140.

In step S402, the processing module 105 scans media files in the external storage device 140.

In step S403, the processing module 105 adds the media files, scanned in the external storage device 140, to the collection.

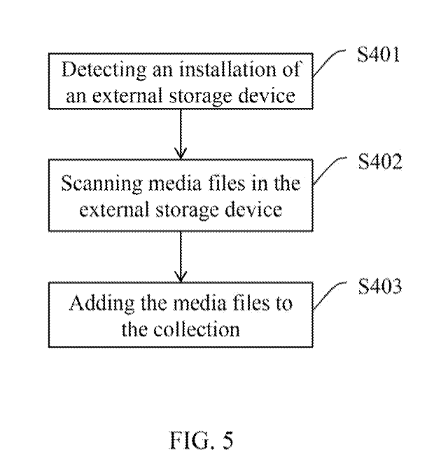

FIG. 5 is a flowchart illustrating one embodiment of a method of managing the collection of media files when an external storage device is uninstalled. The method may include the following steps.

In step S501, the second processing module 106 detects an uninstallation of the external storage device 140.

In step S502, the second processing module 106 determines all files in the external storage device 140 which are media files, out of all the files in the external storage device 140.

In step S503, the second processing module 106 deletes all media files which are located in the external storage device 140 from the collection.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for generating a collection of media files in an electronic device, the method comprising:
specifying one or more locations where media files are stored;
scanning the media files in the one or more locations with a processor of the electronic device;
generating a collection of the media files; and
verifying the media files in the collection and when one of the media files is invalid, deleting the one of the media files from the collection.

2. The method of claim 1, wherein the media files comprising audio files, video files and image files.

3. The method of claim 1, wherein the one or more locations comprise a local storage location of the electronic device.

4. The method of claim 1, wherein the one or more locations comprise a remote storage location on a network.

5. The method of claim 1, wherein the scanning the media files comprises:
scanning extension names of files stored in the one or more locations; and
determining the media files when the extension names of files meet extension name criteria of media files.

6. The method of claim 5, wherein the extension name criteria of media files are stored in a file in an XML format.

7. The method of claim 1, wherein the verifying the media files in the collection comprises:
reading a plurality of bytes from data of one of the media files in the collection;
checking whether the plurality of bytes meets feature codes criteria of media files; and
determining a valid media file when the plurality of bytes meets the feature codes criteria and an invalid media file when the plurality of bytes does not meet the feature codes criteria.

8. The method of claim 7, wherein the feature codes criteria of media files are stored in a file in an XML format.

9. The method of claim 1, further comprising:
detecting an installation of a storage device;
scanning for storage device media files in the storage device; and
adding the storage device media files, located in the storage device, to the collection.

10. The method of claim 1, further comprising:
detecting an uninstallation of a storage device; and
deleting storage device media files located in the storage device from the collection.

11. An electronic device, comprising:
a storage system;
at least one processor;
one or more programs being stored in the storage system and executable by the at least one processor, the one or more programs comprising:
a location module adapted to specify one or more locations where media files are stored;
a scanning module adapted to scan the media files in the one or more locations;
a collection generator adapted to generate a collection of the media files; and
a verifying module adapted to verify the media files in the collection and when one of the media files is invalid, delete the one of the media files from the collection.

12. The electronic device of claim 11, wherein the media files comprising audio files, video files and image files.

13. The electronic device of claim 11, wherein the one or more locations comprise a local storage location of the electronic device.

14. The electronic device of claim 11, wherein the one or more locations comprise a remote storage location on a network.

15. The electronic device of claim 11, wherein the scanning module is further adapted to scan extension names of files in the one or more locations and determine the media files when the extension names of files meet extension name criteria of media files.

16. The electronic device of claim 11, wherein the verifying module is further adapted to read a plurality of bytes from data of one of the media files in the collection, check whether the plurality of bytes meets feature codes criteria of media files, and determine a valid media file when the plurality of bytes meets the feature codes criteria and determine an invalid media file when the plurality of bytes does not meet the feature codes criteria.

17. The electronic device of claim 16, wherein the feature codes criteria of media files are stored in a file in an XML format.

18. The electronic device of claim 11, further comprising a first processing module adapted to detect an installation of a storage device, scan storage device media files located in the storage device, and add the storage device media files to the collection.

19. The electronic device of claim 11, further comprising a second processing module adapted to detect an uninstallation of a storage device and delete storage device media files located in the storage device from the collection.

20. A computer-implemented method for generating a collection of media files in an electronic device, the method comprising:
providing a location module, a scanning module, a collection generator and a verifying module;
specifying, by the location module, one or more locations where media files are stored;
scanning the media files in the one or more locations by the scanning module;
generating a collection of the media files by the collection generator; and
verifying the media files in the collection and when one of the media files is invalid, deleting the one of the media files from the collection by the verifying module.
